(19) United States
(12) Patent Application Publication
(10) Pub. No.: US 2013/0232420 A1
(43) Pub. Date: Sep. 5, 2013

(54) Methods and apparatus for invoking actions on content

(71) Applicants: Johnnie B. Manzari, San Francisco, CA (US); Lance K. Groody, Sebastopol, CA (US); James P. Mohan, Belmont, CA (US)

(72) Inventors: Johnnie B. Manzari, San Francisco, CA (US); Lance K. Groody, Sebastopol, CA (US); James P. Mohan, Belmont, CA (US)

(21) Appl. No.: 11/142,540

(22) Filed: Jun. 1, 2005

(51) Int. Cl. G06F 3/0484

(52) U.S. Cl. CPC G06F 3/0484
USPC 715/730

(57) ABSTRACT

A media player automatically presents portions of content in a sequential manner over time so that a user (or other entity) can focus on reviewing a single portion of content (e.g., a static image, portion of video, music, etc.). As the portions of content are presented, the user can apply one or more applicable commands to respective portions of content in the presented sequence. For example, a user can apply a command such as mark an image for printing. When the media player finishes the sequential presentation of content, the media player provides notification to the user that certain content was marked for printing. Via a dialog box generated by the media player, the user can confirm printing of the marked content.

### BACKGROUND

Use of so-called media players has become quite common in conventional computer applications. In general, a media player is a computer application that presents (e.g., plays back) content such as video, audio, images, slide shows, etc. for a user.

One reason for such a broad acceptance of media players is the convenience afforded by their use. For example, via use of a window-based application, a computer user can open a “window” on a computer screen and review contents of a file (such as a file of digital images) displayed in a respective window. Typically, conventional media players enable a user to control how or which content is presented for review via control commands.

One way of enabling control of a respective media presentation is to enable a user to select a command from a pull-down menu or tool bar appearing in relation to a graphical user interface associated with a media player application executed by a respective computer system. Examples of media player control commands include fast forward, reverse, pause, play, skip to next frame, display previous frame, etc. Different media players support different types of commands. For example, the latter set of mentioned commands (e.g., pause, play, skip to next frame, display previous frame, etc.) apply to media players such as automatic slide shows in which a media player sequentially presents images on a display screen for review. As well known, such commands enable a respective user to selectively play back or display different portions of content on the media player. Certain cameras enable a user to review images as an automatic slide show.

Users can initiate playback of content in other types of conventional applications. For example, conventional digital cameras enable a user to take pictures and thereafter mark respective images for printing. In such applications, the user manually selects and marks different images appearing for review on a miniature display screen of the camera. Thereafter, the user typically downloads the pictures to a computer system that recognizes the images that have been marked for printing. Upon invocation of a command by the user, the computer system communicates respective digital information to a printer to complete printing of marked or tagged images.

### SUMMARY

Conventional techniques enabling review of content such as photo images suffer from a number of deficiencies. For example, as discussed, conventional cameras typically enable respective users to take and store multiple digital pictures. However, the user must click on previous and next buttons of the camera to review and selectively apply tags to different pictures on a respective display screen. Typically, the respective display screen of the camera is quite small and has a poor resolution. The ability to mark pictures in this manner can be cumbersome because a user has to manually select pictures for reviewing and also apply a tagging function to mark images. Also, the user is often unable to judge whether an image should be printed because the resolution of the respective display screen is so bad (because the screen is so small) that the use cannot determine whether an image is blurry or not. Moreover, selection of the pictures occurs in the camera itself rather than in a photo editor application running on a computer system capable of invoking successful printing or further processing of the pictures.

A deficiency of conventional applications such as conventional media players is the inability to perform functions on the content itself For example, as mentioned, conventional media players enable a user to control how or what content is played back rather than apply commands to content.

Techniques discussed herein deviate with respect to conventional applications such as those discussed above as well as additional techniques known in the prior art. In particular, embodiments herein enable selection of content or application of commands to sequentially presented content in order to initiate at least a portion of a respective action (e.g., an action associated with the command such as setting a printer, storing an ID in a queue, etc.) on such content. Based on such an embodiment, a reviewer of the content is not necessarily limited to merely controlling how or what content is presented in a viewing region of the display screen. Instead, a user can apply “content processing” commands and thus different types of actions on respective portions of content as they are presented in a sequential manner to a user.

More specifically, a technique as further described herein involves automatically presenting portions of content in a sequential manner over time so that a user (or other entity) can focus on reviewing a single portion of content (e.g., a static image, portion of video, music, etc.). As portions of content are presented over time, the user can selectively apply one or more applicable commands to respective portions of content in the presented sequence. For example, a user can apply a command such as mark an image for automatic printing at the end of a respective slide show.

In response to receiving one or more applicable commands for presented content, a processing entity according to an embodiment herein automatically initiates at least part of a respective action on a particular portion of content (e.g., a specific image) while such content is presented in a review or playback mode. The respective action applied to the particular portion of content is exclusive of an action used to control a presentation of the portions of content in the sequence. In other words, the action (or portion thereof) initiated in response to an applied command can be a processing function such as print content, copy content, apply tag to content, etc. normally applied in separate conventional post-processing applications. Consequently, a user according to an embodiment herein can completely perform or at least initiate a start of one or more multiple content processing functions (or portion thereof) during a sequential presentation of content. This alleviates the user from having to invoke multiple separate applications to execute specific actions with respect to content.

According to one embodiment herein, a computer application designates a viewing region of a display screen for individually displaying static images (e.g., portions of content) one after another over time. During a sequential presentation of the static images, the computer application displays a first static image in the viewing region for a given amount of time. Thereafter, the computer application automatically displays a second static image in lieu of the first static image, and so on until all of the images have been displayed. As mentioned, the computer application enables a user to initiate one or more commands with respect to particular content in the sequence at a time when the particular content is presented for review in the viewing region of the display screen.

Further functionality associated with an embodiment herein includes simultaneously displaying one or more selectable commands along with content on a display screen. For example, in the context of an automatic slide show that momentarily presents images on a display screen for review as described above, the computer application herein can display a pull-down menu or tool bar of commands that can be applied to currently displayed content. In response to receiving input (e.g., clicking on a pull-down menu) prior to actually receiving selection of a command, the computer application can temporarily pause the a sequence of presenting content so that a user can select and apply a command from a menu to currently presented content. Without the pause feature, the user may accidentally apply a command to a following image in the presentation sequence. Upon application of a command in the pull-down menu or other cue by the user, the computer application can automatically or manually resume the process of presenting the portions of content in the sequence over time so that a user can further review and apply commands to other content.

The computer application keeps track of which commands have been issued with respect to different portions of content in a respective sequential presentation of content by maintaining a unique identifier associated with each respective portion of content presented in a respective sequence. In response to receiving a command for particular content, the computer application retrieves a corresponding identifier (e.g., a media identifier) associated with the particular content and stores the identifier in a buffer. After completion of the sequential presentation of content, the computer application utilizes identifiers in the buffer to identify the portions of presented content chosen by the user in which to apply the command.

After completion of individually displaying portions of content such as images one after another in the viewing region of the display screen, the computer application provides a visual indication on the display screen of a respective command applied to respective content. For example, the computer application provides a visual indication on the display screen of particular content to which a command was applied in order to provide notification to a user of a specific command that was initiated by a user for respective content displayed during the sequential presentation of content.

One way of providing the above notification is to dedicate a viewing region of the display screen to display an identification of an applied command as well as one or more thumbnail images to identify respective content to which the command was applied during a sequential presentation of content. Accordingly, in such an embodiment, after completion of presenting portions of content in a sequential presentation, the computer application automatically displays a visual indication on a display screen to indicate which portion or portions of content were marked during presentation of the content.

After displaying the visual indication that content was marked by a user for applying a certain action, the computer application can receive further input from the user whether to initiate completion of the respective action on the particular portion of content. For example, after a slide show presentation, the computer application can automatically prompt a user with a dialog box that certain content was “marked” during a sequential presentation of content. The dialog box can further query whether a user wishes to proceed with a further application of a respective command on respective marked content. For example, if a user marks several images for printing, the computer application generates a query to the user whether to proceed with and complete printing of the images. Thus, according to an embodiment herein, a user can apply commands to different portions of content as it is presented in a sequential presentation of content.

Other embodiments herein include a computerized device, workstation, handheld or laptop computer, or the like configured with software and/or circuitry (e.g., a processor) to process any or all of the method operations disclosed herein. In other words, a computerized device or a processor that is programmed or configured to operate as explained herein is considered an embodiment of the invention.

Yet other embodiments herein include software programs to perform the steps and operations summarized above and disclosed in detail below. One such embodiment comprises a computer program product that has a computer-readable medium including computer program logic encoded thereon that, when performed in a computerized device having a coupling of a memory and a processor and a display, programs the processor to perform the operations disclosed herein. Such arrangements are typically provided as software, code and/or other data (e.g., data structures) arranged or encoded on a computer readable medium such as an optical medium (e.g., CD-ROM), floppy or hard disk or other a medium such as firmware or microcode in one or more ROM or RAM or PROM chips or as an Application Specific Integrated Circuit (ASIC). The software or firmware or other such configurations can be installed onto a computerized device to cause the computerized device to perform the techniques explained herein.

Accordingly, one particular embodiment of the present application is directed to a computer program product that includes a computer readable medium having instructions stored thereon for invoking actions on selected content. The instructions, when carried out by a processor of a respective computer device, cause the processor to perform the steps of: i) automatically presenting portions of content in a sequence over time; ii) receiving a command associated with a particular portion of content in the sequence at a time when the particular portion of content is presented in the sequence; and iii) in response to receiving the command, automatically initiating at least part of a respective action on the particular portion of content, the respective action being exclusive of an action used to control a presentation of the portions of content in the sequence. Other embodiments of the present application include software programs to perform any of the method embodiment steps and operations summarized above and disclosed in detail below.

It is to be understood that the system according to an embodiment herein can be embodied strictly as a software program, as software and hardware, or as hardware alone such as within a processor, or within an operating system or a within a software application. Example embodiments of the invention may be implemented within products and/or software applications manufactured by Adobe Systems, Inc. of San Jose, Calif., USA.

As discussed above, techniques herein are well suited for use in computer systems that play back or present content such as images, video, audio, etc. types of information. However, it should be noted that techniques herein are discussed with respect to specific example embodiments and that such techniques herein are well suited for other applications as well. Additional features of the present application will be further discussed via the Detailed Description section of this application as well as accompanying figures.

### BRIEF DESCRIPTION OF THE DRAWINGS

The foregoing and other objects, features, and advantages of the invention will be apparent from the following more particular description of preferred embodiments herein, as illustrated in the accompanying drawings in which like reference characters refer to the same parts throughout the different views. The drawings are not necessarily to scale, with emphasis instead being placed upon illustrating the embodiments, principles and concepts.

FIG. 1 is a diagram of a sequence of content presented to a user during a sequential presentation of content by a media player according to an embodiment herein.

FIG. 2 is a screenshot of a media player application presenting a list of content processing commands that can be applied to presented content according to an embodiment herein.

FIG. 3 is a screenshot of a media player application indicating which content processing commands were applied to respective content during a sequential presentation of content according to an embodiment herein.

FIG. 4 is a block diagram of a processing device suitable for executing a media player application according to an embodiment herein.

FIG. 5 is a flowchart illustrating techniques associated with a media player application according to an embodiment herein.

FIG. 6 is a more detailed flowchart illustrating techniques associated with a media player application according to an embodiment herein.

### DETAILED DESCRIPTION

According to one embodiment, a media player automatically presents portions of content in a sequential manner over time so that a user (or other entity) can at least momentarily focus on reviewing a single portion of content (e.g., a static image, portion of video, music, etc.) being presented. As each of the portions of content is temporarily presented, the user can apply one or more applicable content processing commands (e.g., print, tag, edit, delete, copy, etc.) to a currently presented portion of content. For example, a user can apply a content processing command such as mark an image for printing of the image at the end of a respective automatic presentation of content. In addition to enabling invocation of content processing commands during a review mode, the media player application herein can also present a set of media player control commands as well. The media player control commands enable the user to control how content is played back by the media player.

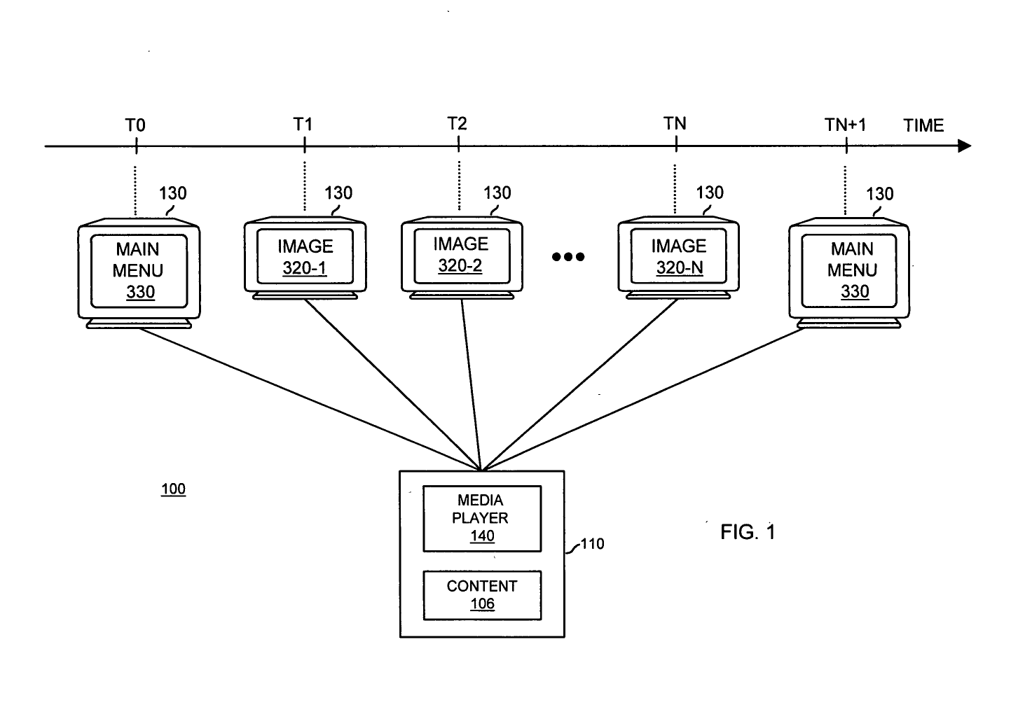

FIG. 1 is a timing diagram of content 106 presented to a user during a sequential presentation of content 106 by a media player 140 according to an embodiment herein. In general, media presentation environment 100 illustrates how media player 140 running on computer system 110 presents content 106 on display screen 130 over time.

As shown, media player 140 initiates a display of main menu 330 (e.g., a graphical user interface) on display screen 130 at time TO. The main menu 330 enables a user to initiate an automatic presentation of content 106 (e.g., images 320) on display screen 130.

In response to user input to main menu 330 such as initiation of a slide show presentation, media player 140 starts the sequential presentation of content (e.g., images 320) on display screen 130. For example, based on content 106, media player 140 initiates display of image 320-1 on display screen 130 between time T1 and time T2. Media player 140 initiates display of image 320-2 on display screen 130 between time T2 and time T3, and so on. Accordingly, the images 320 appearing on display screen 130 are displayed for at least a predetermined amount of time (e.g., typically several seconds or more) so that the user 108 (or other entity) can review a single portion of displayed content 106 (e.g., a static image, portion of video, music, etc.). In this case, the user 108 has invoked media player 140 to display images 320 for review. However, as mentioned, it should be noted that media player 140 can play back other types of content as well.

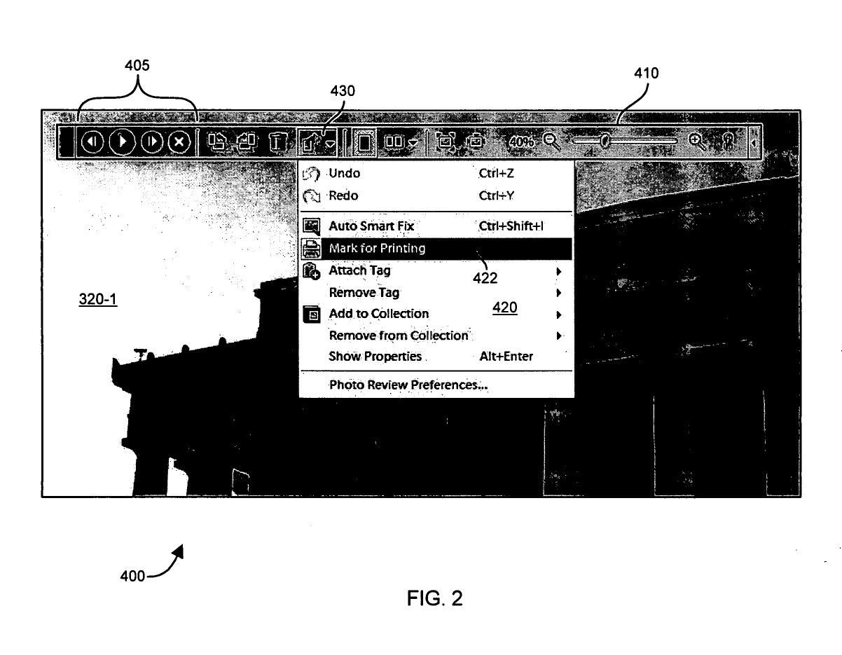

During sequential presentation of images 320, media player 140 enables a user to apply content processing commands with respect to currently displayed images 320. This is more particularly shown in FIG. 2. In general, FIG. 2 is a screenshot 400 of an example image 320-1 as well as a tool bar 410 displayed along with example image 320-1. A respective tool bar 410 can be displayed for each of the images 320 shown in FIG. 1. The tool bar 410 includes selectable icons enabling a user to select and apply different content processing commands to images 320 as they are presented on display screen 130 to a user for review. Based on user input such as selection of a command in the pull-down menu 420, the user 108 can select a particular command to apply to an image 320 currently displayed on display screen 130.

Tool bar 410 also enables a user to control what content appears on display screen 130. For example, tool bar 410 includes respective selectable icons 405 to initiate reverting back to a previous image in a slide show, pause, go to a next image in a slide show, etc.

In comparison to display commands associated with selectable icons 405, commands listed in pull-down menu 420 of tool bar 410 enable a user to initiate actions such as print content, delete content, copy content, apply tag to content, mark images for later editing, etc. These latter commands do not effect how media player 140 sequentially presents content for review as do display commands associated with selectable icons 405.

According to conventional methods, these latter functions are normally applied in separate post-processing applications. However, a user according to an embodiment herein can completely perform or at least initiate a start of one or more multiple content processing functions (or portion thereof) during a sequential presentation of content based upon application of commands in pull-down menu 410 during a slide show. This alleviates the user from having to invoke multiple separate applications to produce the same processing results such as print images, delete images, mark images for editing, etc.

In response to receiving one or more applicable content processing commands for presented images 320, media player 140 according to an embodiment herein automatically initiates at least part of a respective action on a particular portion of content during the respective sequential presentation of content 106. For example, media player 140 queues up images for printing based on receipt of a respective command (e.g., “mark for printing” command 422) from a user (e.g., a specific image) while such content is presented in a review or playback mode on display screen 130. This enables the media player 140 to simply send each image separately off to a printer immediately upon viewing or wait until a number of images have been tagged for printing before executing a print operation. According to the latter embodiment, a printing process herein allows a collection of images and printing of same based on a common format to a single page or a handful of pages instead of one page per image.

In addition to queuing images for printing, prior to completion of an automatic slide show, the media player 140 can automatically perform actions such as set up a printer for printing or set up a network connection with a website to transmit respective images for further processing. Consequently, at the end of a slide show, at least a portion of background tasks or setup tasks associated with applied commands can be completed so that a user can more quickly complete a respective task associated with the applied commands. As an alternative, media player 140 also can identify certain tasks associated with an applied command but wait until completion of a slide show presentation to prompt a user whether to further proceed with execution or completion of such commands on corresponding selected content.

One feature of tool bar 410 is the ability to automatically pause a sequential presentation of content 106 when a user clicks on icon 430 to initiate display of pull-down menu 420 and thereafter apply a content processing command to currently displayed content. In response to receiving input (e.g., clicking on icon 430), the media player 140 temporarily pauses the sequence of presenting content 106 so that a user can select and apply a command from pull-down menu 420 to a currently presented image 320. Without this pause feature, the user may accidentally apply a command to a following unintended image in the presentation sequence.

After selection of a command in the pull-down menu 420, the media player 140 automatically resumes the process of presenting the portions of content in the sequence over time on display screen 130 so that a user can further review and apply commands to other presented content.

In alternative embodiments, each image 320 presented to a user does not include tool bar 410 and respective pull-down menu 420. Instead, media player 140 is configured to detect the occurrence of a user right clicking a mouse while an associated pointer is over a displayed image 320 on display screen 130. In response to the action of right clicking a mouse, the media player 140 generates a pull-down menu similar to pull-down menu 420 so that a respective user can select and apply a command to a currently displayed image 320. Similar to the embodiment discussed above, right clicking a mouse can additionally result in pausing a respective slide show so that the current image on display screen 130 is not overwritten by a following image and user has time to select an appropriate command to the currently displayed content.

According to another configuration, media player 140 detects the occurrence of a user pressing a certain sequence of keys on a keyboard to detect when a respective use applies a command to currently displayed content. For example, a user may press the letter “p” on a respective keyboard to indicate that an image currently displayed on display screen 130 should be marked for printing. The user may press the letter “e” on a respective keyboard to indicate that an image currently displayed on display screen 130 should be marked for editing.

Additionally, the media player according to an embodiment herein can enable a user to define or specify a type of action to be associated with a type of user input. For example, the user can define what action to apply to respective content on a display screen 130 in response to a type of input initiated by a user. In one embodiment, the user may configure media player 140 so that mere clicking of a mouse by a user causes a current image on display screen 130 to be marked for printing. In another embodiment, the user can configure media player 140 so that certain types of tagging commands applied to respective images viewed in automatic slide show are automatically sent to one or more remote entities via e-mail. In this instance, the user can pre-specify remote entities to receive content tagged by execution of a corresponding tagging command in an automatic slide show.

According to one configuration, the media player 140 keeps track of which commands have been issued with respect to different portions of content presented during a respective sequential presentation by maintaining a unique identifier associated with each respective portion of content presented in a respective sequence. In response to receiving a command for particular content, the media player 140 identifies a corresponding identifier (e.g., a media identifier) associated with the particular content to which the command has been applied and stores the identifier in a buffer. After completion of the sequential presentation of content, and in some cases before completion of the sequential presentation of content, the media player 140 utilizes identifiers in the buffer to identify the portions of presented content chosen by the user in which to apply the command.

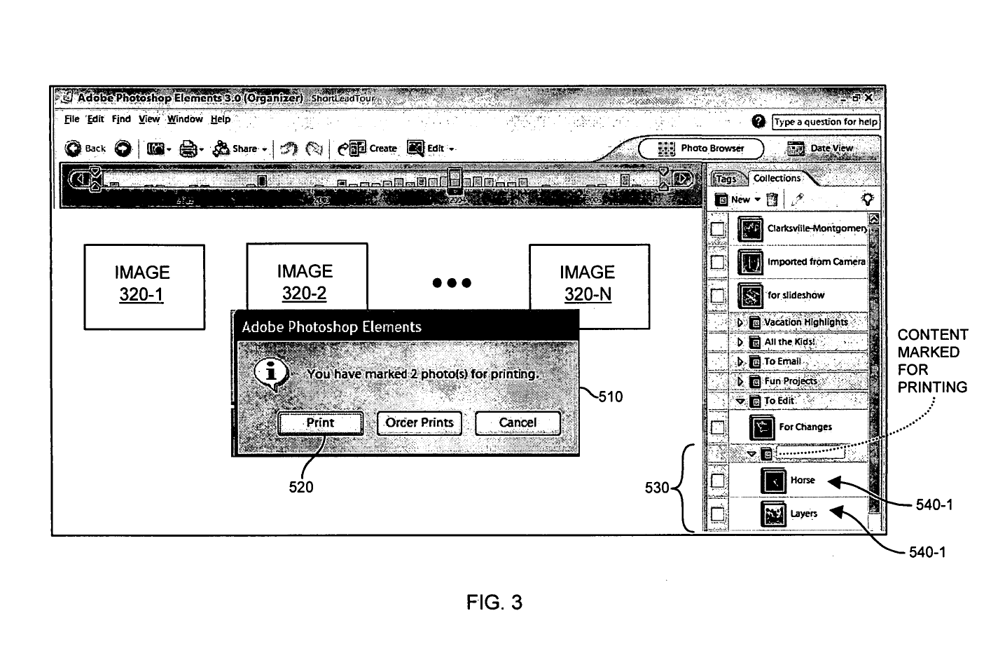

Referring again to FIG. 1, after completing the sequential presentation of content by temporarily displaying the last image 320-N on display screen 130 and enabling a user to apply respective content processing commands in pull-down menu 420, media player 140 again initiates display of main menu 330 to user 108 at time TN+1. However, the main menu 330 (e.g., graphical user interface associated with media player 140) displayed by media player 140 at time TN+1 includes a notification of which commands were applied during the sequential presentation of images 320. An example of this is more particularly shown in FIG. 3.

In general, FIG. 3 includes a dialog box 510 providing notification to a user that two images (as identified by respective thumbnail image 540-1 and thumbnail image 540-2) were marked for printing during a sequential presentation of content as discussed in FIGS. 1 and 2. The user can easily complete printing of any marked images 320 by clicking on the “print” icon 520 in the dialog box 510 because the respective content has already been queued for printing.

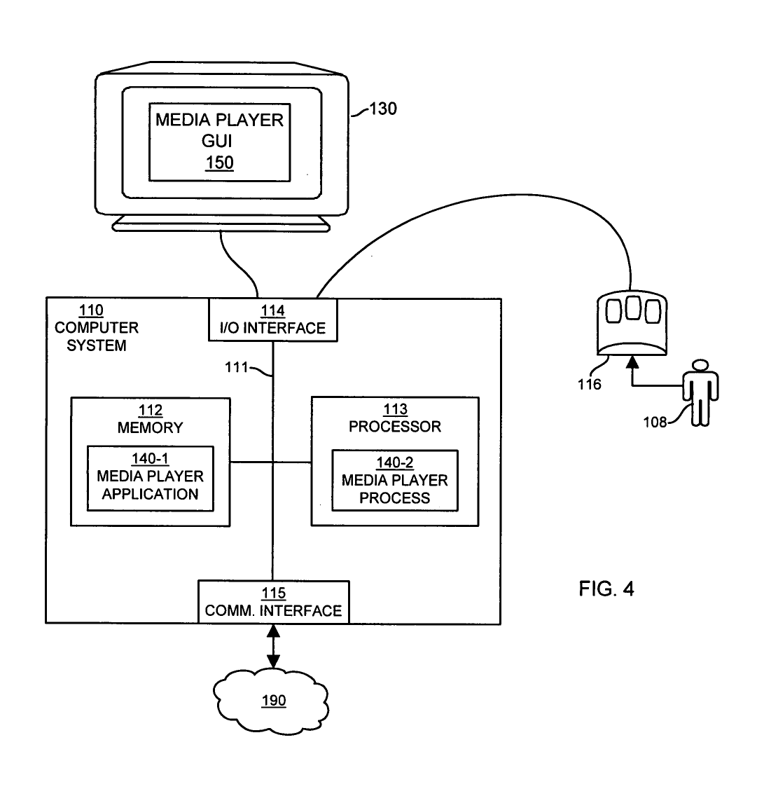

In addition to initiating display of the dialog box 510, media player 140 provides a visual indication of content processing commands applied to respective portions of sequentially presented content. For example, media player 140 displays thumbnails 540 of respective images 320 in display region 530 to indicate that a user marked such images for printing during the sequential presentation of content as discussed in FIG. 1. In other words, display region 530 indicates that the user applied the “mark for printing” command 422 (in the pull-down menu 420 of FIG. 4) to both of the images represented by thumbnail image 540-1 and thumbnail image 540-2 at a time when they were sequentially presented on display screen 130. Accordingly, the media player 140 provides a visual indication on the display screen 130 of particular content to which a command was applied.

In one embodiment, the media player 140 provides a list of each command issued during a sequential presentation of content and corresponding portions of content to which the respective commands were applied. Thus, embodiments herein can provide a visual indication that a first type of command was applied to a first set of content while a second type of command was applied to a second set of content. The first and second set of content need not be exclusive of each other. In other words, two different types of commands can be applied to the same content 106.

One way of providing the above notification is to dedicate a buffer for each possible command that can be applied during the sequential presentation of content. Each time user applies a command to displayed content, media player 140 stores a media identifier in the respective buffer for that command. In this way, the media player 140 can track and provide a notification of which of multiple commands were applied to respective portions of content during review.

FIG. 4 is a block diagram illustrating an example architecture of a computer system 110 for executing media player application 140-1 according to embodiments herein. Computer system 110 can be a computerized device such as a personal computer, workstation, portable computing device, console, network terminal, processing device, etc. As shown, computer system 110 of the present example includes an interconnect 111 that couples a memory system 112, a processor 113, I/O interface 114, and a communications interface 115. I/O interface 114 potentially provides connectivity to peripheral devices such as a keyboard, mouse, display screen 130, etc. Communications interface 115 enables computer system 110 to communicate over network 190 to retrieve and transmit information from remotely located sources if necessary. Media player graphical user interface 150 enables user 108 to review content and apply content processing commands as previously discussed.

As shown, memory system 112 is encoded with a media player application 140-1 supporting playback, review, and/or application of commands to content (e.g., static images, video images, audio, etc. Media player application 140-1 may be embodied as software code such as data and/or logic instructions (e.g., code stored in the memory or on another computer readable medium such as a disk) that supports processing functionality according to different embodiments described herein. During operation, processor 113 accesses memory system 112 via the interconnect 111 in order to launch, run, execute, interpret or otherwise perform the logic instructions of the media player application 140-1. Execution of the media player application 140-1 produces processing functionality in media player process 140-2. In other words, the media player process 140-2 represents one or more portions of the media player application 140-1 (or the entire application) performing within or upon the processor 113 in the computer system 110.

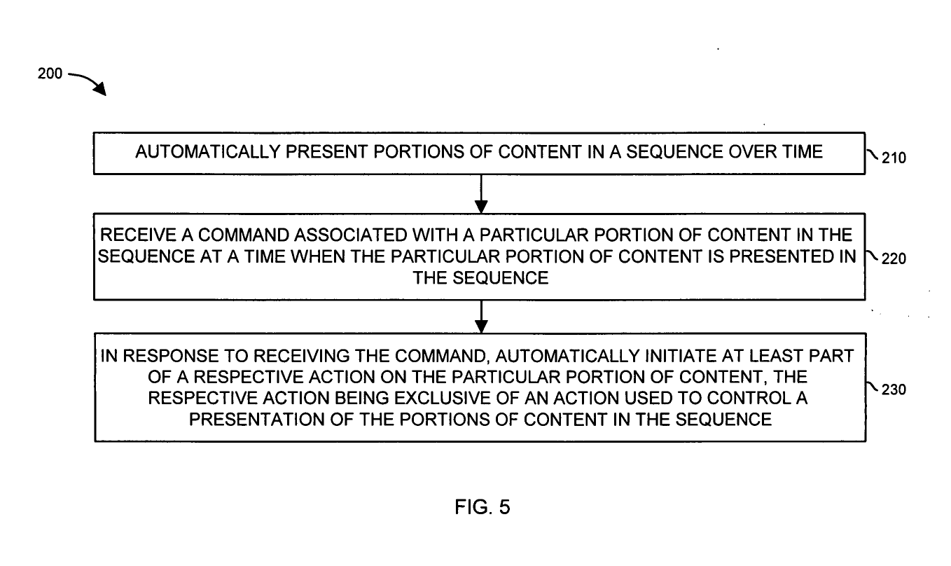

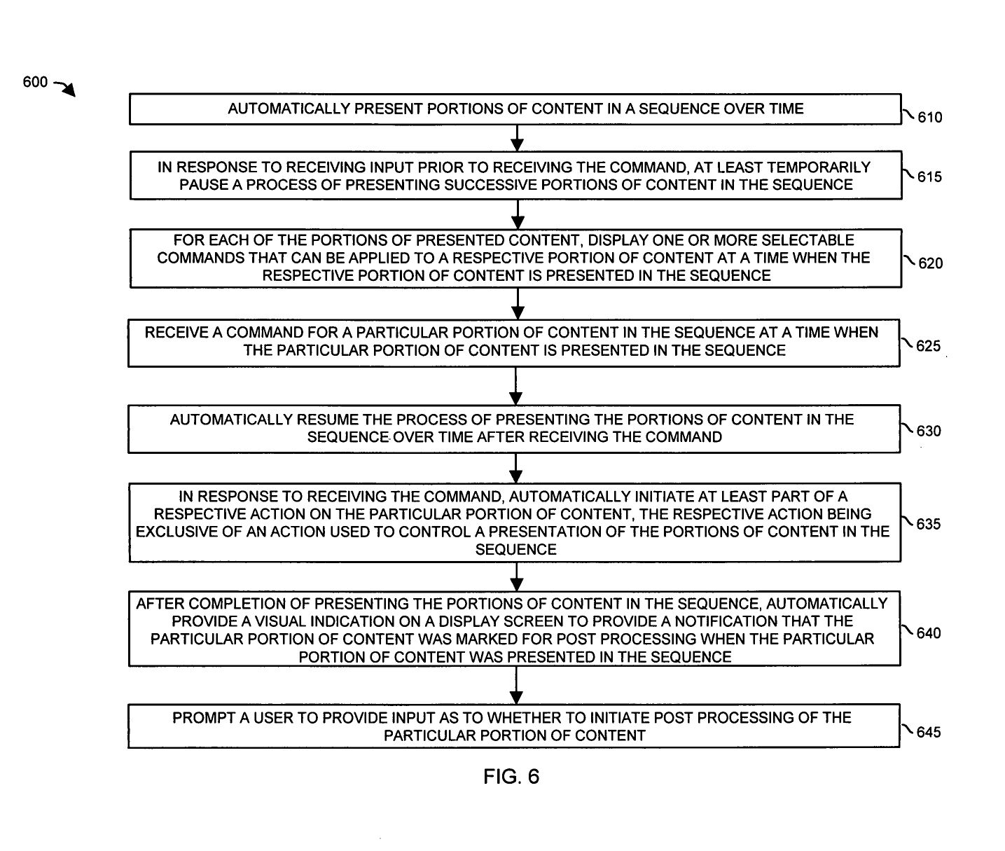

It should be noted that media player 140 displayed on display screen 130 (as in FIG. 1) can be represented by either one or both of the media player application 140-1 and/or the media player process 140-2. For purposes of the following discussion, general reference will now be made to the computer system 110 or respective media player 140 as performing or supporting the various steps and functional operations in flowcharts of FIGS. 5 and 6 to carry out the features of embodiments herein.

It also should be noted that, in addition to the media player process 140-2, embodiments herein include the media player application 140-1 itself (i.e., the un-executed or non-performing logic instructions and/or data). The media player application 140-1 may be stored on a computer readable medium such as a floppy disk, hard disk or in an optical medium. The media player application 140-1 can also be stored in a memory type system such as in firmware, read only memory (ROM), or, as in this example, as executable code within the memory system 112 (e.g., within Random Access Memory or RAM). In addition to these embodiments, it should also be noted that other embodiments herein include the execution of media player application 140-1 in processor 113 as the media player process 140-2. Thus, those skilled in the art will understand that the computer system 110 can include other processes and/or software and hardware components, such as an operating system that controls allocation and use of hardware resources.

Functionality supported by computer system 110 and, more particularly, functionality associated with media player 140 and media player graphical user interface 150 will now be discussed via the general flowchart in FIG. 5. For purposes of this discussion, computer system 110 or media player 140 (e.g., media player application 140-1 and/or media player process 140-2) generally performs steps in the flowcharts.

FIG. 5 is a flowchart 200 illustrating a technique of sequentially presenting content according to an embodiment herein. As discussed, one purpose of presenting content is to enable a user to apply content processing commands to respective portions of content as they are momentarily presented to a user.

In step 210, media player 140 automatically presents portions of content in a sequence over time.

In step 220, media player 140 receives a command associated with a particular portion of content in the sequence at a time when the particular portion of content is presented in the sequence.

In step 230, in response to receiving the command, media player 140 automatically initiates at least part of a respective action on the particular portion of content, the respective action being exclusive of an action used to control a presentation of the portions of content in the sequence.

FIG. 6 is a flowchart 600 illustrating a summary of certain techniques as discussed above. The below description of steps in flowchart 600 may include references to items (e.g., computer system 110, media player 140, etc.) previously discussed in FIGS. 1-5.

In step 610, media player 140 automatically presents portions of content in a sequence over time on display screen 130.

In step 615, in response to receiving input prior to receiving the command, media player 140 at least temporarily pauses a process of presenting successive portions of content in the sequence.

In step 620, for each of the portions of presented content, media player 140 displays one or more selectable commands that can be applied to a respective portion of content at a time when the respective portion of content is presented in the sequence.

In step 625, media player 140 receives a command for a particular portion of content in the sequence at a time when the particular portion of content is presented in the sequence.

In step 630, media player 140 automatically resumes the process of presenting the portions of content in the sequence over time after receiving the command.

In step 635, in response to receiving the command, media player 140 automatically initiates at least part of a respective action on the particular portion of content, the respective action being exclusive of an action used to control a presentation of the portions of content in the sequence. The respective action can include marking the particular portion of content prior to completion of a process of presenting the portions of content in the sequence.

In step 640, after completion of presenting the portions of content in the sequence, media player 140 automatically provides a visual indication on a display screen to provide a notification that the particular portion of content was marked for post processing when the particular portion of content was presented in the sequence.

In step 645, media player 140 prompts a user to provide input as to whether to initiate post processing of the particular portion of content.

Note again that techniques herein are well suited for use in applications such as media player applications. However, it should be noted that configurations herein are not limited to use in such applications and thus configurations herein and deviations thereof are well suited for other applications as well.

While this invention has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting. Rather, any limitations to the invention are presented in the following claims.

1-37. (canceled)

38. A computer-implemented method comprising:
presenting a plurality of digital images for display in a slide show on a display screen, the slide show including displaying each of the plurality of images for a respective predetermined period of time and in a predetermined sequence, wherein the plurality of images comprise separately-captured pictures;
during presentation of each of the plurality of digital images, displaying a set of actions that can be applied to a digital image currently displayed in the slide show;
during presentation of a given digital image in the slide show, receiving selection of an action from the set of actions to be applied to the given digital image;
providing a visual indication on the display screen to provide a notification that the selection of the action was received, the visual indication indicating the action to be applied to the given digital image; and
subsequent to completing display of each of the plurality of digital images in the slide show, initiating execution of the selected action with respect to the given digital image.

39. A computer-implemented method as in claim 38 further comprising:
after completion of presenting the slide show:
displaying a notification prompting a user to provide input as to whether to initiate the processing on the given digital image.

40. The computer-implemented method as in claim 38 further comprising:
initiating execution of a content processing function to execute the selected action, the content processing function being independent of a presentation process that initiates presentation of the slide show on the display screen.

41. The computer-implemented method as in claim 40, wherein the content processing function is a print operation that executes independent of a display application presenting the slide show on the display screen.

42. The computer-implemented method as in claim 38 further comprising:
in response to receiving the selection of the action to be applied to the given digital image, storing an identifier associated with the given digital image to indicate that the given digital image was marked for application of post processing after the slide show.

43. The computer-implemented method as in claim 38 wherein the visual indication on the display screen comprises:
a first visual indication to indicate the selection of the action with respect to the given digital image; and
a second visual indication to indicate that the action has been applied.

44. The computer-implemented method as in claim 38 further comprising:
displaying a symbol on the display screen while the given digital image is displayed on the display screen during the slide show, the symbol representing the action that can be applied to the given digital image during the slide show; and
wherein receiving the command includes receiving selection of the symbol at time when the given digital image is displayed in the slide show.

45. The computer-implemented method as in claim 38 further comprising:
in response to receiving selection of the action, identifying a corresponding identifier associated with the given digital image;
storing the identifier in a buffer; and
after completion of presenting the slide show on the display screen, utilizing the identifier in the buffer to identify that the given digital image was selected during presentation of the given digital image in the slide show.

46. The computer-implemented method as in claim 38 further comprising:
in response to receiving input prior to receiving selection of the action, at least temporarily pausing the slide show; and
automatically resuming presentation of the slide show in response to receiving selection of the action.

47. The method as in claim 38, wherein the given digital image is a first digital image in the slide show, the method further comprising:
displaying a second digital image in the slide show;
during presentation of the second digital image in the slide show:
displaying the set of actions to indicate that the set of actions can be applied to the second digital image;
receiving selection of the action for application to the second digital image, the method further comprising:
subsequent to completing display of each of the plurality of digital images in the slide show, initiating execution of the action to the first digital image and the second digital image.

48. A computer-implemented method comprising:
displaying, on a display screen, digital images in a slide show, the digital images including at least a first digital image and a second digital image, wherein the digital images comprise separately-captured pictures;
initiating display of the first digital image in the display screen for a predetermined duration of time;
while initiating display of the first digital image on the display screen:
initiating display of multiple different actions that can be applied to the first digital image;
receiving selection of the action from the multiple different actions that can be applied, the action selected by a user for applying to the first digital image;
initiating a visual indication on the display screen to provide a notification that the user previously selected the action for applying to the first digital image;
after expiry of the predetermined duration of time, initiating display of the second digital image on the display screen in lieu of displaying the first digital image on the display screen; and
subsequent to completing display of each of the digital images on the display screen, initiating execution of the selected action with respect to the first digital image.

49. (canceled)

50. The computer-implemented method as in claim 48 further comprising:
displaying an execute command in the notification, the execute command indicating that the action can be applied to the first image based on selection of the execute command; and
in response to receiving selection of the execute command displayed in the notification, initiating execution of the action with respect to the first digital image.

51. The computer-implemented method as in claim 48, wherein the action is a first action of multiple different actions displayed on the display screen, the method further comprising:
while initiating display of the second digital image on the display screen:
initiating display of a menu of the multiple different actions on the display screen;
receiving, from the user, selection of a second action from the menu, the second action being different than the first action.

52. The computer-implemented method as in claim 51 further comprising:
subsequent to completing display of each of the digital images in the slide show on the display screen:
initiating execution of the first action with respect to the first digital image, and
initiating execution of the second action with respect to the second digital image.

53. The computer-implemented method as in claim 48 further comprising:
in response to completing display of the digital images on the display screen, automatically initiating execution of the action with respect to the first digital image.

54. The computer-implemented method as in claim 48 further comprising:
in response to receiving the selection of the action, tagging the first digital image for automatic distribution to at least one pre-specified remote entity via e-mail after completion of displaying the slide show.

55. The computer-implemented method as in claim 48 further comprising:
initiating at least part of the selected action on the first digital image before completion of displaying the slide show.

56. The computer-implemented method as in claim 48 further comprising:
after completion of displaying the slide show on the display screen:
prompting a user making the selection of the first action whether to apply a respective operation associated with the first action to the first digital image; and
prompting a user making the selection of the second action whether to apply a respective operation associated with the second action to the second digital image.

57. (canceled)

58. The method as in claim 38, wherein displaying the set of actions includes:
displaying a first icon on the display screen, the first icon representing a first action that can be applied to the given digital image as the given digital image is currently displayed in the slide show; and
displaying a second icon on the display screen, the second icon representing a second action that can be applied to the given digital image as the given digital image is currently displayed in the slide show.

59. The method as in claim 58, wherein receiving selection of the action includes receiving selection of the first icon while the given digital image is displayed on the display screen.

60. The method as in claim 59, wherein initiating execution of the selected action includes applying the first action to the given digital image after completing presentation of the slide show on the display screen.

61. The method as in claim 59 further comprising:
after completing the slide show, providing notification on the display screen, the notification indicating that the first action was selected for application to the given digital image during the slide show; and
wherein applying the first action to the given digital image includes:
after completing presentation of the plurality of digital images in the slide show, receiving further input via the display screen, the further input indicating to initiate execution of the first action with respect to the given digital image.

62. (canceled)

63. The computer-implemented method as in claim 38, wherein the visual indication on the display screen comprises a dedicated viewing region, the dedicated viewing region displaying a thumbnail image of the given digital image marked for processing and an identification of the action to be applied to the given digital image.
